(19) United States
(12) Patent Application Publication
(10) Pub. No.: US 2004/0015410 A1
(43) Pub. Date: Jan. 22, 2004

(54) Data trading system

(75) Inventor: Masatoshi Kimura, Tokyo (JP)

Correspondence Address: MCDERMOT, WILL & EMERY, 600 13th Street, N.W., WASHINGTON, DC, 20005-3096, US

(73) Assignee: MITSUBISHI DENKI KABUSHIKI KAISHA

(21) Appl. No.: 10/339,319

(22) Filed: Jan. 10, 2003

(30) Foreign Application Priority Data
Jul. 17, 2002 (JP) 2002-208501

(51) Int. Cl. G06F 17/60

(52) U.S. Cl. 705/26

(57) ABSTRACT

A data trading system discloses a part of data to a buyer to facilitate network transactions. The system includes a seller terminal, a buyer terminal and an intermediary terminal. The seller terminal transmits a selling request for selling data relevant to a technology and the data. The seller terminal includes an input unit used for entering a specification code that represent specification of contents of the technology, and transmits the specification code with the data. The buyer terminal transmits a buying request for buying the data. The intermediary terminal has a storage which holds the data from the seller terminal and a processor which transmits the data to the buyer terminal based on the selling and the buying request. The intermediary terminal further stores the specification code from the seller terminal and transmits the contents of the specification to the buyer terminal based on a request from the buyer terminal.

### BACKGROUND OF THE INVENTION

1. Field of the Invention

The present invention relates to a technique for trading data via a computer network.

2. Description of the Background Art

In recent years, commodity exchange via a computer network such as Internet (network transactions) is popularly practiced. Network transactions are carried out in two primary forms. One is that only orders are placed via the network and commodities are sent via mailing, etc. The other is that both orders and commodities are transferred via the network in the case the commodities are electronic data (for example, software). Consequently, commodities that are subject to network transactions not only apply to physical “things” but also include various kinds of “information” which are expressed by electronic data.

In traditional network transactions, electrical schematic diagrams describing parts of electric circuits and their interconnections have not been commodities intended for business. The reason is that such electrical schematic diagrams are confidential information to which technical know-how of manufacturers is concentrated.

However, in other words, electrical schematic diagrams have remarkably high value and unless the secret is leaked more than necessary, they are extremely promising as commodities for business. For example, if the buyer is a person who plans to newly launch into a circuit developing field and can utilize information of electrical schematic diagrams which have been dormant due to suspension or discontinuation of development, or halt or end of production in a company, electrical schematic diagrams which were theoretically achieved by preeminent ideas in venture companies but were unable to be commercially produced due to shortage of development resources, or electrical schematic diagrams of specialty fields prepared by retired individuals, the development cost and amount of investment can be reduced. In addition, general companies on the seller side could promote in-house ventures, while venture companies and individuals could commercialize electrical schematic diagrams only, even if they cannot manufacture products. That is, by transferring the information of extremely high added-value making the best of global Internet characteristics, both information providers and information receivers can create new businesses and at the same time, for information receivers, additional new business deployment and business activities will become possible.

### SUMMARY OF THE INVENTION

It is an object of the present invention to disclose a part of data to data purchasers and facilitate network transactions.

A data trading system includes a seller terminal, a buyer terminal and an intermediary terminal. The seller terminal transmits a selling request for selling data relevant to a technology and the data. The seller terminal includes an input unit used for entering a specification code that represent specification of contents of the technology, and transmits the specification code with the data. The buyer terminal transmits a buying request for buying the data. The intermediary terminal has a storage which holds the data from the seller terminal and a processor which transmits the data to the buyer terminal in receipt of the selling and the buying request. The intermediary terminal further stores the specification code from the seller terminal and transmits the contents of the specification to the buyer terminal in receipt of a request from the buyer terminal.

Therefore, not only secrete of the information before selling can be kept but also the data buyer has a chance to judge utilization value of the information by investigating the contents of specifications. Professional production subcontractors can expand new businesses by acquiring the data of technologies with good growth prospects. Venture companies and in-house venturers can promote business chances.

The technology-related data is electrical schematic diagrams including drawings that describe, for example, interconnections of wiring of electrical circuits and lists of parts that compose the relevant electrical circuits. Consequently, buyers can reduce development cost and investment amount by purchasing electrical schematic diagrams. Sellers can obtain new profits using the developed electrical schematic diagrams. Specifically, in view of the recent conditions in which storage of analog engineers is aggravated and high-frequency techniques are frequently incorporated into part of products that satisfy broadband Internet access requirements (high-speed, high-frequency, wide band), it is possible to greatly cut development cost and shorten work periods by purchasing electrical schematic diagrams such as high-frequency circuits. Leading companies and leading venturers can recover expenses, even part of investment, because they can sell electrical schematic diagrams which they no longer need.

### BRIEF DESCRIPTION OF THE DRAWINGS

This and other objects and features of the present invention will become clear from the subsequent description of a preferred embodiment thereof made with reference to the accompanying drawings, in which like parts are designated by like reference numerals and in which:

FIG. 1 is a schematic diagram of a network transaction system according to the present invention;

FIG. 2 is an schematic diagram of appearance of computer;

FIG. 3 is a block diagram of a seller terminal;

FIG. 4 is a block diagram of an intermediary server;

FIG. 5 is a block diagram of a buyer terminal;

FIG. 6 is a flow chart of a procedure of network transaction system;

FIG. 7 is a diagram classifying categories in the specifications;

FIG. 8 is a diagram of classification indicating to which category a schematic diagram belongs in the specifications;

FIG. 9 is an illustration explaining the classification shown in FIG. 8 in a specific example;

FIG. 10 is a hierarchy diagram of more specific example of minimum functional component connection diagram;

FIG. 11 is an illustration of the first corresponding relation between specific contents of specifications and specification codes;

FIG. 12 is an illustration of the second corresponding relation between specific contents of specifications and specification codes;

FIG. 13 is an illustration of the third corresponding relation between specific contents of specifications and specification codes;

FIG. 14 is an illustration showing an example of electrical schematic diagram of SRAM card which can be an object of selling;

FIG. 15 is an illustration showing an example of electrical schematic diagram of SRAM card which can be an object of selling;

FIG. 16 is an illustration showing an example of electrical schematic diagram of SRAM card which can be an object of selling;

FIG. 17 is a list of parts composing the electric circuit;

FIG. 18 is an illustration showing an example of specification codes automatically created:

FIGS. 19A-19D are illustrations showing an example of score determined with respect to category and connection diagram classification;

FIGS. 20A and 20B are illustrations showing an example of score determined with respect to identification of specifications (1) and (2);

FIG. 21 is an illustration showing an example of score determined with respect to identification of specifications (3);

FIG. 22 is an illustration showing calculation results of scores of SRAM cards which have acquired specification codes shown in FIG. 18;

FIG. 23 is an illustration showing an example of list of information (main specifications, incidental matters, prices, etc.) related to electrical schematic diagrams of SRAM described with reference to FIGS. 14 through 17;

FIG. 24 is an illustration showing a display of sample data concerning circuit diagram; and

FIG. 25 is an illustration showing a display of sample data concerning parts list.

### DETAILED DESCRIPTION OF THE PREFERRED EMBODIMENTS

Referring now to the drawings attached, preferred embodiments of the present invention will be described as follows.

In the present specification, commodity transactions via one or more computer networks such as Internet (hereinafter called the “network transaction”) will be described. The subject of network transactions is information expressed by electronic data, and to be more specific, data of an electrical schematic diagram. The electrical schematic diagram includes one or more drawings describing interconnections of wiring, etc. of an electric circuit and lists of parts that compose the electric circuit. “Wiring interconnections, etc.” refers to drawings that show electric circuits, electric equipment/facilities and communication equipment/facilities and general indoor wiring and their interconnections, and control systems prepared by electrical and drawing symbols prescribed in such as Japanese standard JISC0301, JISC0303, JISC0401 or standards which are not governed by these (for example, drawing symbols by MIL standard), etc. Note that electrical schematic diagrams may be limited to drawings that describe interconnections, etc. of wiring of electric circuits only.

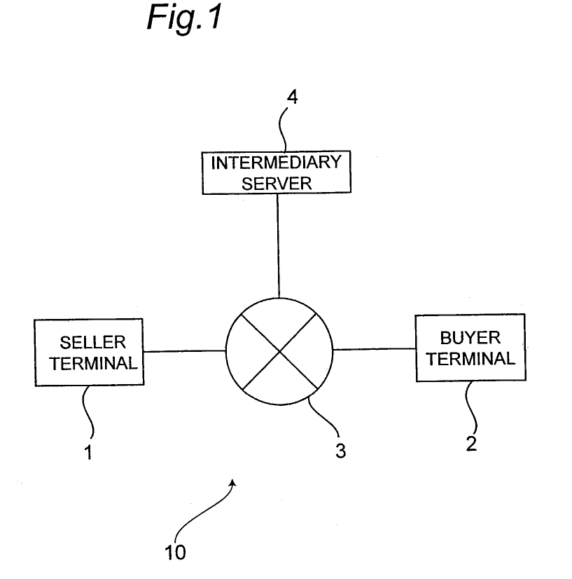

FIG. 1 is a schematic representation showing a network transaction system 10 according to the present invention. Network transaction system 10 includes seller terminal 1, buyer terminal 2, network 3, and intermediary server 4. In network transaction system 10, intermediary server 4 holds electrical schematic diagram data requested to be sold from seller terminal 1 and sells a desired electrical schematic diagram data according to a purchase request from buyer terminal 2. Transmissions of selling request, purchase request, and electrical schematic diagram data are sent via network 3. Network 3 is a computer network (public network) such as Internet.

In FIG. 1, only one seller terminal 1 and one buyer terminal 2 are shown, but both of them may exist in a plurality. In addition, only one intermediary server 4 is shown. This is for convenience of holding and control of electrical schematic diagram data. However, if this holding and control can be performed without any problem, a plurality of intermediary servers 4 may exist.

Intermediary server 4 carries out data communications with seller terminal 1 and buyer terminal 2, respectively, and achieves main functions of network transaction system 10. In the present specification, on intermediary server 4, Web sites are operated, and seller terminal 1 and buyer terminal 2 access the Web sites and enter the predetermined request. Intermediary server 4 receives data from seller terminal 1 and buyer terminal 2, and transmits the processing results based on the data to them.

More specifically, intermediary server 4 is equipped with the following functions. That is, (1) display of specifications of electrical schematic diagrams, display of price, and display of samples of electrical schematic diagrams intended for transactions, (2) holding of electrical schematic diagrams (databank), (3) granting of specification code of electrical schematic diagrams and reproduction of the specifications, (4) decision of prices of electrical schematic diagrams, (5) reception and distribution of electrical schematic diagrams, and (6) electronic account settlement.

Seller terminal 1 is used by a person who sells electrical schematic diagrams, for example, circuit manufacturers, public institutions, and individuals. Seller terminal 1 adds specifications related to the electrical schematic diagram to the electrical schematic diagram which the seller desires to sell and transmits to intermediary server 4. “Specifications” of electrical schematic diagrams is information that enumerates one or more electric functions, electric characteristics, one or more added value functions, etc. of electric circuits expressed by the electrical schematic diagrams. Specifications are added by an operator of seller terminal 1 by executing a specification code setting program later discussed given by intermediary server 4.

Buyer terminal 2 is used by a person who purchases electrical schematic diagrams. Terminal 2 corresponds to, for example, one or more terminals in companies such as venture companies, etc. and public institutions. Buyer terminal 2 refers to information concerning electrical schematic diagrams held in intermediary server 4 and send a decision whether to purchase or not. The information concerning electrical schematic diagrams includes titles, specifications, etc. of electrical schematic diagrams. It may include electrical schematic diagrams, part of which is hidden. In the case that the buyer decides to purchase the data of electrical schematic diagrams, the buyer settles accounts to obtain the data.

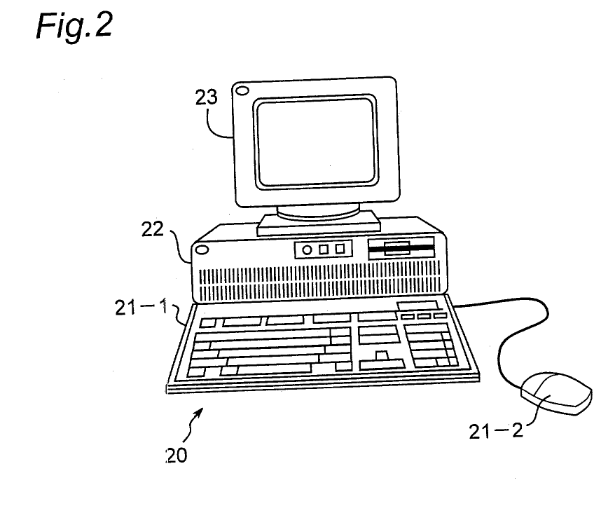

Seller terminal 1, buyer terminal 2, and intermediary server 4 are realized as computers which can communicate via networks. FIG. 2 is an illustration showing the appearance of computer 20. Computer 20 includes keyboard 21-1 and mouse 21-2 by which a user enters data, main body 22 which carries out main information processing such as holding data, processing, doing arithmetic, etc., and display 23 which displays data computed, held, etc. Next discussion will be made on the specific configuration of seller terminal 1, buyer terminal 2, and intermediary server 4.

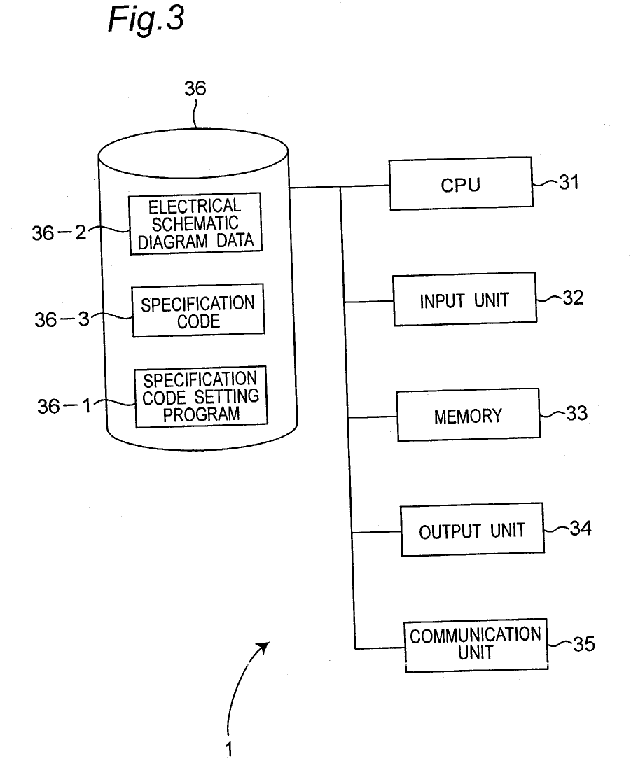

FIG. 3 is a block diagram showing a configuration of seller terminal 1. Seller terminal 1 includes central processing unit (CPU) 31, input unit 32, memory 33, output unit 34, communication unit 35, and hard disk drive (HDD) 36.

CPU31 controls actions of seller terminal 1. As described above, functions of CPU31 of seller terminal 1 related to the present invention are to add specification code for expressing specifications of an electrical schematic diagram to the data of the electrical schematic diagram which the seller desires to sell and transmits the data to intermediary server 4 as composite data. The input unit includes one or more devices such as keyboard 21-1, mouse 21-2 (FIG. 2), used for entering the data and operating seller terminal 1. Memory 33 is random access memory (RAM) that functions as main storage for storing the data. Output unit 34 includes display 23 (FIG. 2) for displaying processing results of CPU31 and data received from intermediary server 4. Communication unit 35 has well-known communication functions for outputting data to network 3 and receiving data from network 3. For example, if network 3 is Internet, network 3 establishes communications based on Internet protocol.

HDD36 is secondary storage which can store a large amount of data. HDD36 has specification code setting program 36-1 received from intermediary server 4 in advance, electrical schematic diagram data 36-2 which is intended for selling, and specification code 36-3. HDD36 does not need to constantly hold specification code 36-3 but may transmit specification code 36-3 to intermediary server 4 (FIG. 1) later discussed as soon as the user prepares specification code 36-3. Specification code setting program 36-1 is described in a programming language such as HTML language utilized for displaying Web sites, and displays alternatives for setting specification codes when executed. Electrical schematic diagram data 36-2 is image data of electrical schematic diagrams that is content of trading. Specification code 36-3 is a symbol (code) that represents specifications entered by the seller. Specification code 36-3 may not be particularly provided when a user on the seller side directly enters specification code 36-3.

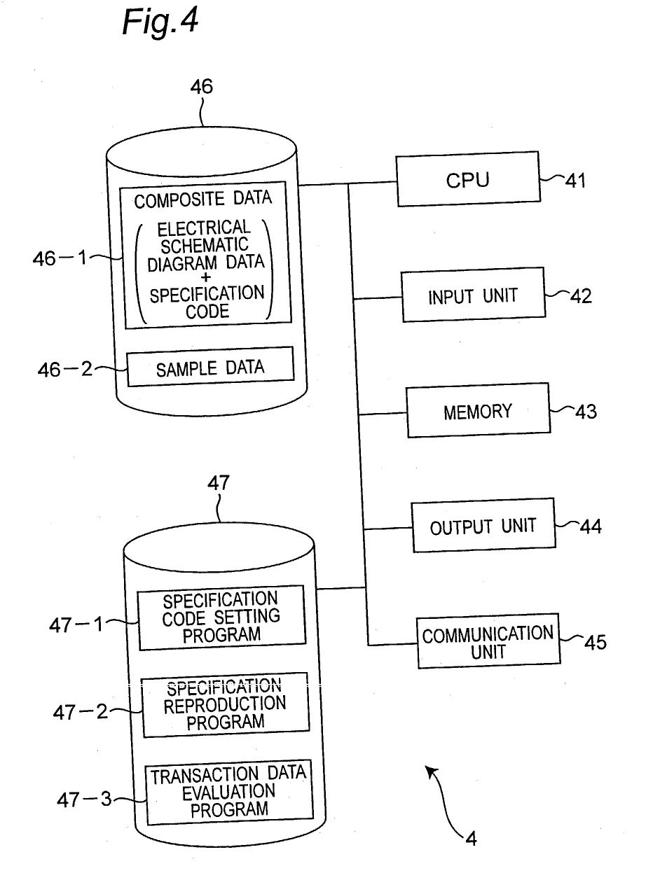

Now, FIG. 4 is a block diagram showing a configuration of seller terminal. Similar to seller terminal 1 (FIG. 3), intermediary server 4 includes central processing unit (CPU) 41, input unit 42, memory 43, output unit 44, communication unit 45, and hard disk drives (HDD) 46, 47. In the Figure, HDD46, 47 are divided into two units for convenience of explanation but may be provided in one hard disk drive. These basic functions are the same as central processing unit (CPU) 31, input unit 32, memory 33, output unit 34, communication 35, and hard disk drive (HDD) 36 of seller terminal 1 (FIG. 3) described by referring to FIG. 2. Consequently, functions and actions specific to intermediary server 4 only are described hereinafter.

CPU41 carries out control and arithmetic for achieving functions (1) through (6) described above. That is, CPU41 reads out specification data of electrical schematic diagram data (composite data) 46-1 with specification code added, which is received from seller terminal 1 (FIG. 3), executes specification reproduction program 47-2, and obtains specifications. In addition, CPU41 executes transaction data evaluation program 47-3 and evaluates the data, and decides price of the electrical schematic diagram. CPU41 creates sample data 46-2 of electrical schematic diagrams with main portions masked, which are highly confidential. Mask processing is a known image processing technique, and for example, is the processing for superimposing an opaque mask image over the image of electrical schematic diagrams and making the image under the superimposed section non-display.

The specifications, price, and samples prepared in this way are outputted to output unit 44. Intermediary server 4 receives composite data 46-1 from seller terminal 1 via communication unit 45 and stores in HDD46. Sample data 46-2 is also stored in HDD46. Consequently, HDD46 is also called data bank. On the other hand, specification reproduction program 57-2 and transaction data evaluation program 47-3 are stored in HDD47 in advance. HDD47 also stores the specification code setting program to be transmitted to seller terminal 1 (FIG. 3).

Communication unit 45 receives data from both seller terminal 1 and buyer terminal 2. HDD46 stores composite data and the sample data received from seller terminal 1 (FIG. 2).

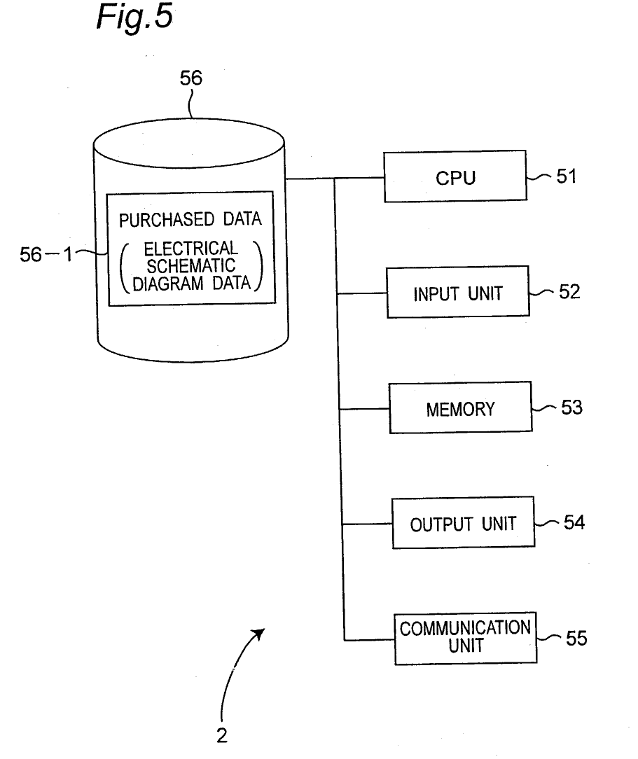

Next, FIG. 5 is a block diagram showing a configuration of buyer terminal 2. Buyer terminal 2 includes central processing unit (CPU) 51, input unit 52, memory 53, output unit 54, communication unit 55, and hard disk drive (HDD) 56. These basic functions are the same as those of central processing unit (CPU) 31, input unit 32, memory 33, output unit 34, communication unit 35, and hard disk drive (HDD) (FIG. 3) of seller terminal 1 described by referring to FIG. 2. Consequently, in the following section, functions and actions specific to buyer terminal 2 only will be described.

CPU51 of buyer terminal 2 transmits purchase request/decision of non-purchase of electrical schematic diagrams, and receives information such as titles, specifications, etc. of electrical schematic diagrams, and furthermore, sample data of electrical schematic diagrams. When electrical schematic diagrams are purchased, CPU51 further transmits information such as credit card No., etc. necessary for settlement processing and receives electrical schematic diagram data. CPU51 stores the electrical schematic diagram data received in HDD56.

Next discussion will be made on how each one of seller terminal 1 (FIG. 1, FIG. 3), buyer terminal 2 (FIG. 1, FIG. 5), and intermediary server 4 (FIG. 1, FIG. 4) transfers requests and data to and from one another in network transaction system 10 (FIG. 1) in order of procedures.

In order to achieve a system much closer to actual embodiments, seller terminal 1 and buyer terminal 2 must be brought into a condition that enables them to transact with intermediary server 4 in advance. Specifically, seller terminal 1 and buyer terminal 2 must be enrolled on the list of membership of intermediary server 4. For the procedure for enrolment, buyers and sellers. must access the Web site of intermediary server 4 and apply for registration by, for example, “new member registration—corporation.” Intermediary server 4 requests sellers and buyers for information necessary for becoming a member, for example, in the case of a company, information on a person who represents the company and takes responsibilities in trading electrical schematic diagrams. If the matters seems to have no problem, the membership is registered and member No. and password for identifying seller terminal 1 and buyer terminal 2 are issued.

By registering the membership, seller terminal 1 is allowed to download specification code setting program 47-1 stored in intermediary server 4 HDD47. By downloading specification code setting program 47-1, it becomes possible to create specification data to be added to electrical schematic diagrams desired to be sold.

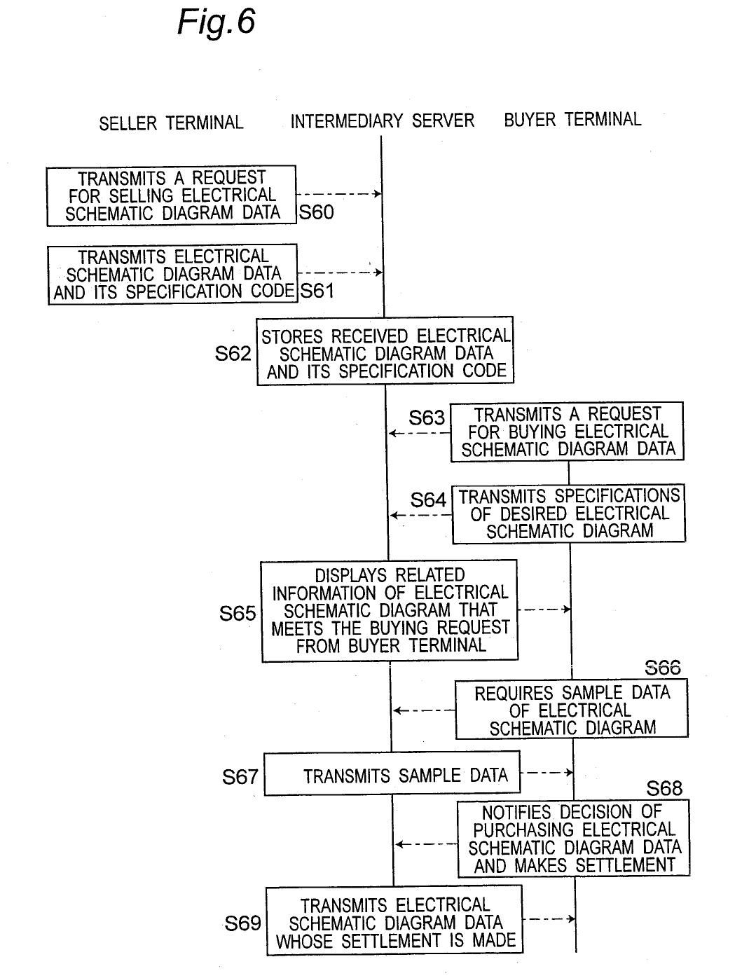

Assuming that the above procedures have already been completed, referring now to FIG. 6, actions of network transaction system 10 will be described. FIG. 6 is a flow chart showing procedures of network transaction system 10. First of all, seller terminal 1 (FIG. 1) transmits a request for selling electrical schematic diagram data to intermediary server 4 together with membership No. and password (Step S60). A user executes specification code setting program 36-1 (FIG. 3) and sets specifications of electrical schematic diagram data 36-2 (FIG. 3) intended for selling. This program has an interface that indicates alternatives (radio buttons for selection, etc.) for setting the specification code and allows entry of specification codes by a simple operation, for example, clicking corresponding buttons by the user. When specifications setting is completed, seller terminal 1 adds the content to electrical schematic diagram data as specification code and transmits to intermediary server 4 (Step S61).

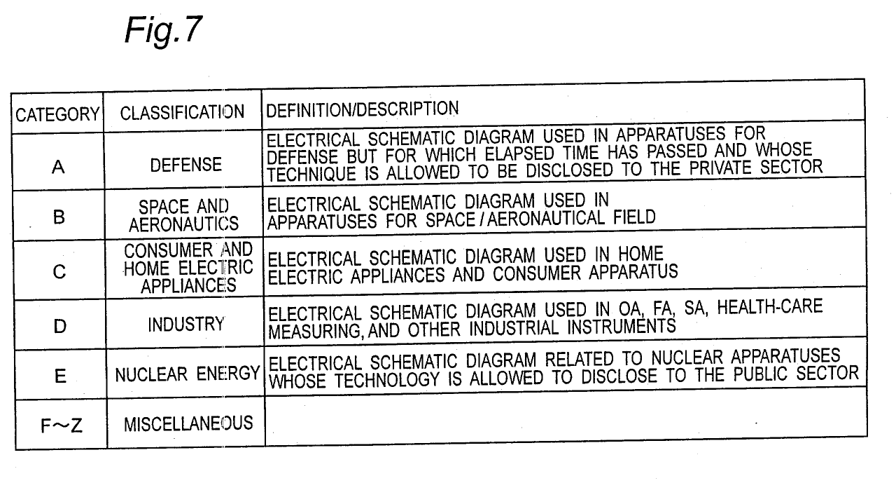

Now, contents of specifications will be explained specifically. FIG. 7 is a diagram classifying categories in the specifications. In this case, specifications are categorized into specific divisions A through E (A: defense; B: space and aeronautics; C: consumer and home electric appliances; D: industry; E: nuclear energy) and other divisions F through Z. Divisions shown here are merely examples and it is needless to say that specifications can be appropriately set in other ways than this.

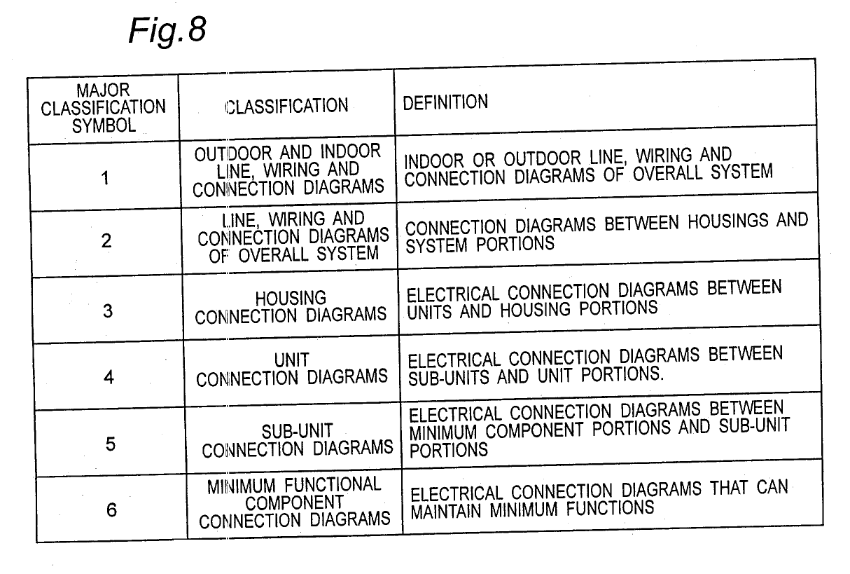

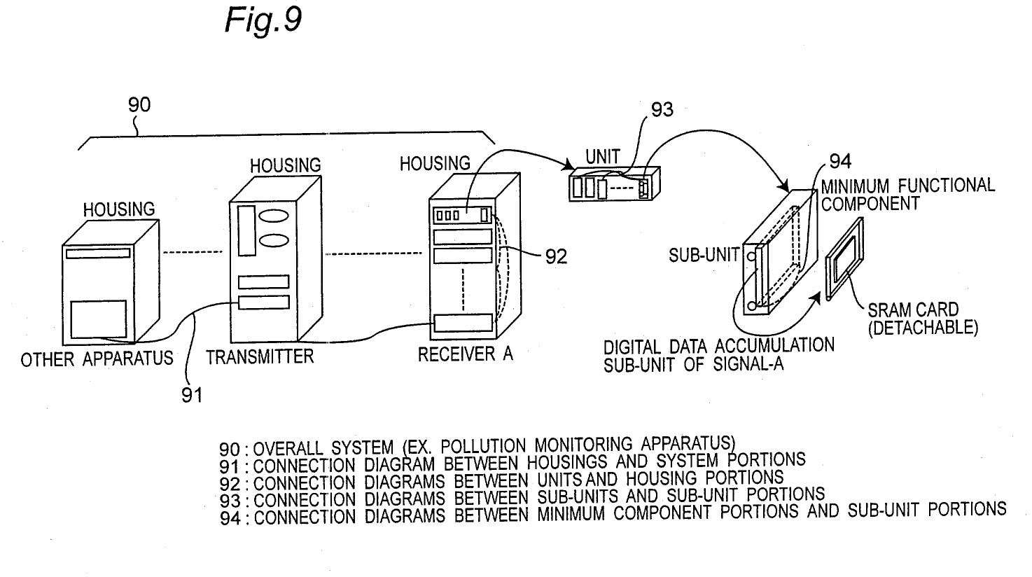

Next, FIG. 8 is a diagram showing classification indicating to which category the electrical schematic diagram belongs in the specifications. “Category” means the position (division) to be connected in an electrical system. Six general divisions are shown. FIG. 9 is an illustration that explains the division shown in FIG. 8 using a specific example. This example shows the appearance image in pollution monitoring apparatus, positioning of relevant connection diagrams, and connection diagram divisions. Pollution monitoring apparatus themselves are installed in government offices and companies, and the overall apparatus is configured by housings, the housing includes each unit having one or more sub-units. Each sub-unit includes SRAM card and parts incidental to the sub-unit. The SRAM card is the minimum functional component.

In the case that an electrical schematic diagram is a diagram that shows connections between system component elements, and more specifically, a diagram that represents connections 91 between housings and system portions such as connections between transmitter housing and receiver housing, etc., the electrical schematic diagram becomes an overall system diagram (symbol 2 of FIG. 8). In the case that an electrical schematic diagram falls under connections 92 between units and housing portions, the electrical schematic diagram becomes housing connection diagram (symbol 3 of FIG. 8). In the case that an electrical schematic diagram falls under connections 93 between subunits including units in housings, the electrical schematic diagram becomes unit connection diagram (symbol 4 of FIG. 8). In the case that an electrical schematic diagram is a diagram that shows connections 94 between minimum component portions and sub-unit portions, the electrical schematic diagram becomes sub-unit connection diagram (symbol 5 of FIG. 8). In the case of connections for maintaining the minimum functions of card inside illustrated as detachable SRAM card, the electrical schematic diagram becomes minimum functional component connection diagram (symbol 6 of FIG. 8).

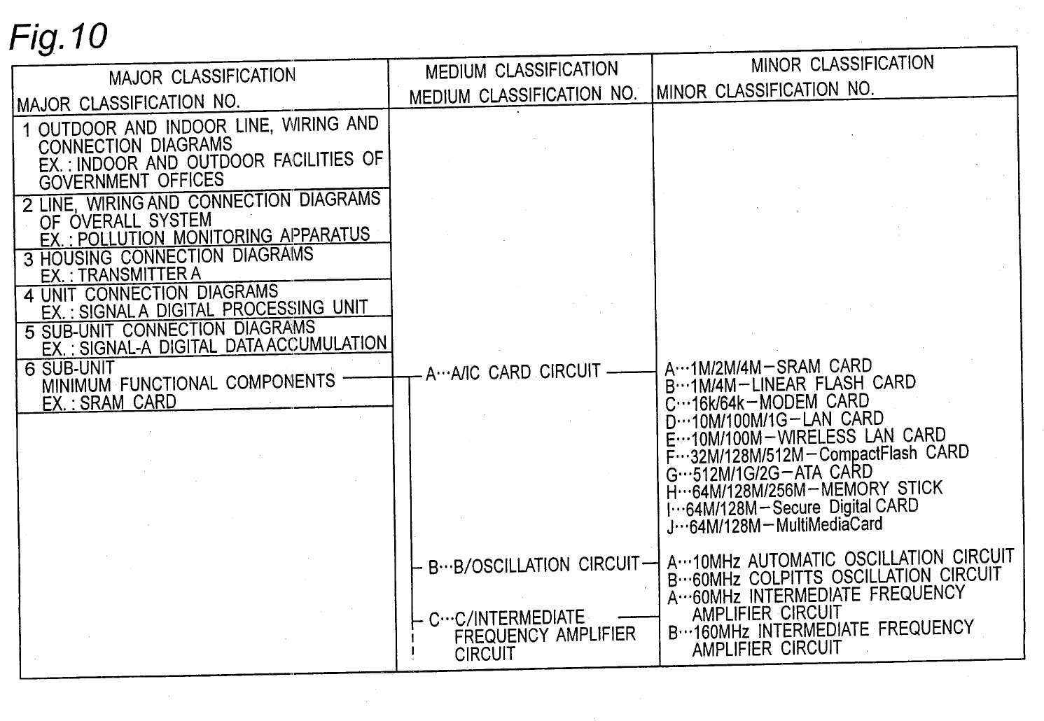

FIG. 10 is a hierarchy diagram showing more specific example of minimum functional component connection diagram. According to FIG. 10, it is understood that under major classification, there exists medium classification such as IC card circuit A, transmitter circuit B, and intermediate frequency amplifier circuit C, and under each of them, there exists minor classification that can specifically identify memory capacity and card standard, respectively.

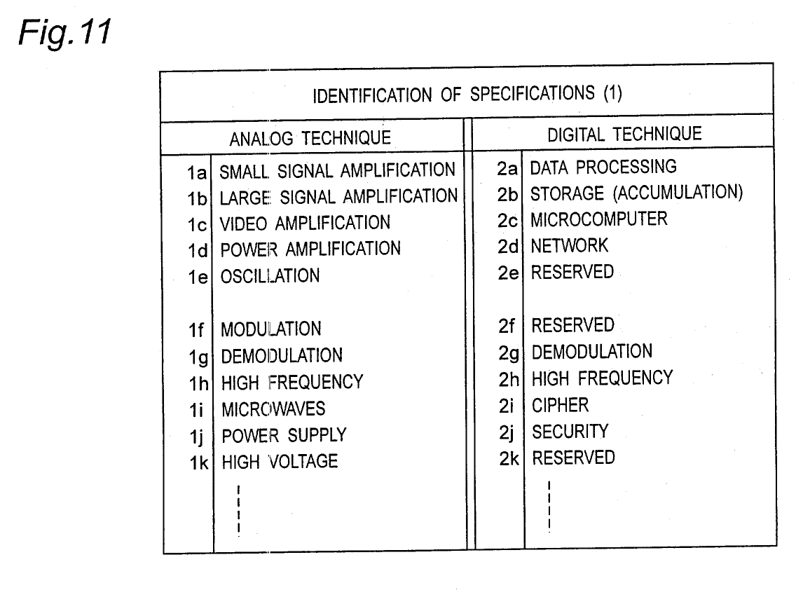

Next, FIG. 11 is an illustration showing the first corresponding relation between specific contents of specifications and specification codes. The specification code in this case is classified by a plurality of characters, and with the first numerical character, whether a technique is an analog technique or digital technique is identified, and with the next alphabetical character, a specific function (small signal amplification, power amplification, storage, etc.) is identified.

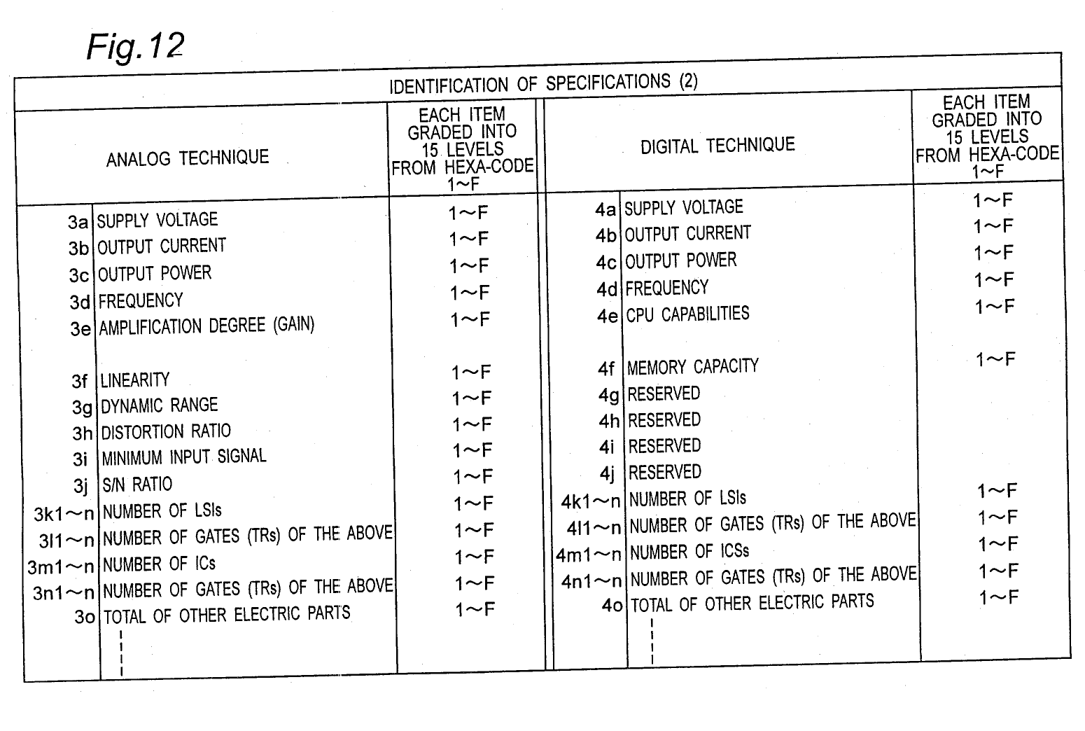

FIG. 12 is an illustration showing the second corresponding relation between specific contents of specifications and specification codes. in this case, by entering specific values to necessary items, specifications can be identified. For example, “1.5 V,” etc. are set to “supply voltage” of Item 3a or chosen from the cited range and values. As a result, each item is classified (graded) into 15 stages from 1 through F by hexadecimal digit. The specification code is expressed by combining the item name with the level. In this example, the specification code is expressed as “3a3”, for example. Note that if a plurality of pins, etc. exist, the specifications can be identified for each pin. Ranking is carried out not by simply dividing the specification value into 15 equal portions but absolutely based on the added value. For example, the value can be unequally divided into 5V, 5V-3.3V, 3.3V-1.8V, etc. From the practical viewpoint, it is assumed necessary to divide each specification into levels 01 through FF (hexadecimal digit), that is, about 255 levels. This specification is utilized when the electrical schematic diagram is evaluated as later discussed. Access to the classified level shall be generally denied. In addition, specification codes A, B, C, . . . , and F described in FIG. 7, and weighted values later discussed will not be disclosed, either.

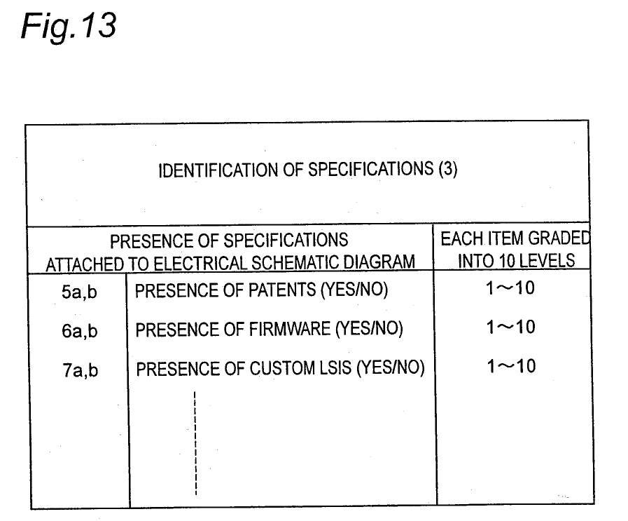

FIG. 13 is an illustration showing the third corresponding relation between specific contents of specifications and specification codes. Here identified are specifications indicating the added value which cannot be grasped only from the relevant electrical schematic diagram. The specification code is also classified by a plurality of characters. According to the presence of specific characteristics, “a” or “b” is attached to the numerical item code. With respect to this specification, in order to utilize it when electrical schematic diagrams are evaluated, each item is graded into 10 levels from 1 through 10 by decimal numeral. This level is set in accordance with the procedures of specification setting program. Note that a user on seller terminal 1 (FIG. 3) may directly enter the level via entry section 32.

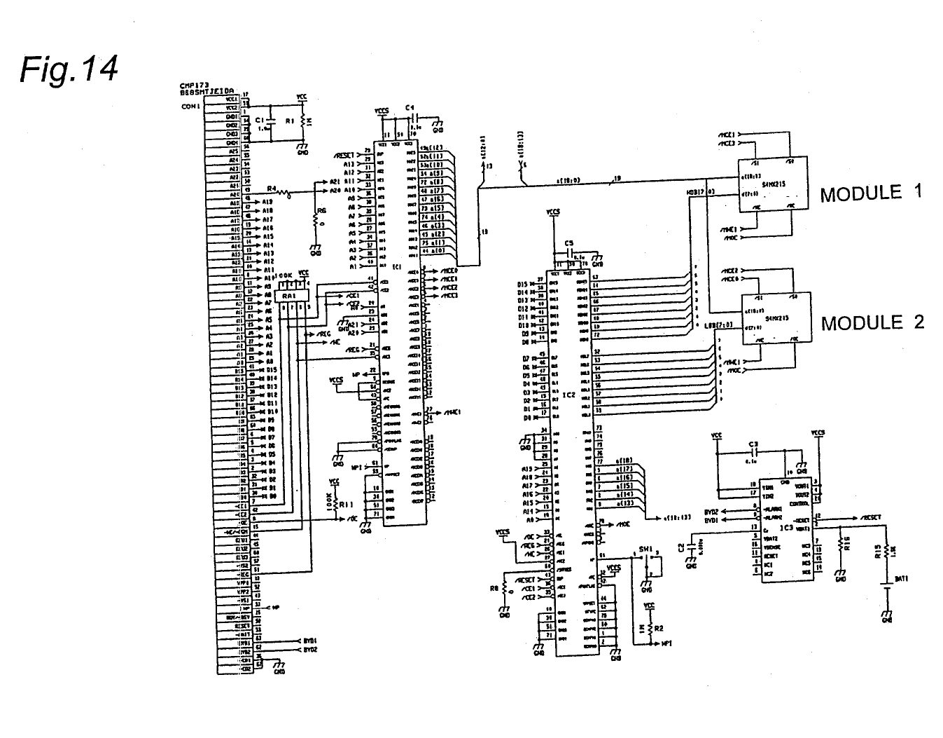

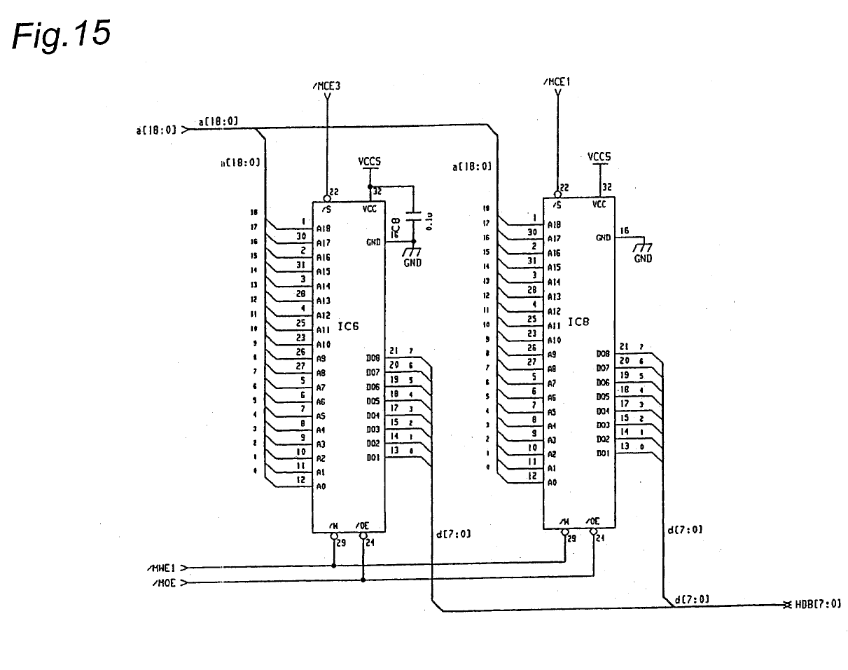

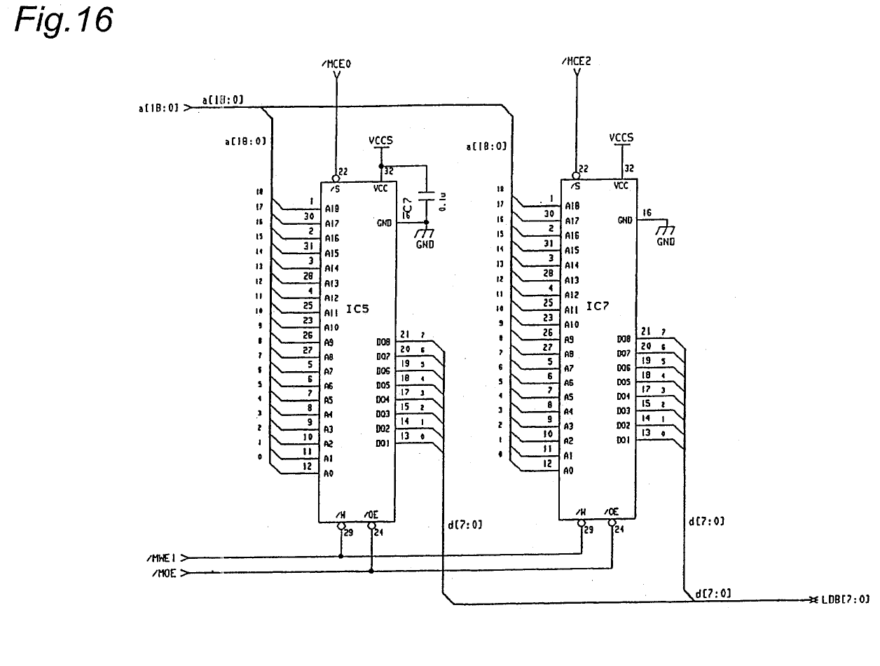

As described above, referring now to FIGS. 14 through 18, specification codes to be set will be specifically described. In the following example, assumed is the case in which a certain company developed and mass-produced pollution-monitoring apparatus including SRAM cards, but suspended the development by change of corporate policy, and hopes to sell electrical schematic diagrams of the SRAM card. That is, it is assumed that the relevant company as a user on seller terminal 1 (FIGS. 1 and 3) hopes to sell electrical schematic diagrams of SRAM card (2M byte) that complies with the PCMCIA standard. Needless to say, selling is carried out after obtaining approval of the responsible personnel of the function.

FIGS. 14, 15, and 16 show examples of electrical schematic diagram of SRAM card intended for sale. It is noted that these figures are divided into three portions for convenience only and not for purposes of limiting transactions to be carried out individually.

The user on seller terminal 1 (FIGS. 1 and 3) executes a specification code setting program downloaded from intermediary server 4 (FIG. 4) and enters individual specifications based on the instructions. That is,

1) For the category shown in FIG. 7, D (industry) is chosen. This is because SRAM card is a component element of pollution-monitoring apparatus.

2) For the connection division shown in FIG. 10, “6” (minimum functional component) is chosen for major classification, “IC card circuit” for medium classification, and “2M byte SRAM card” for minor classification.

3) In identification of specifications (1) shown in FIG. 11, “2b” (storage (accumulation)) is chosen. This is because SRAM card is one of storage devices.

4) In identification of specifications (2) shown in FIG. 12, ten items are chosen as follows and at the same time, suitable items are chosen by clicking specifications graded into 15 ranks for each item. If there are not 10 suitable items, suitable items only shall be clicked. In this identification of specification (2), maximum 10 items shall be chosen.

| | Specification code |
|---|---|
| “Supply voltage”: Click 1.8 V | 3 |
| “Output current”: Click 50 mA | 3 |
| “Output power”: Click 100 mW/gate. | 2 |
| “Frequency”: Click 20 MHz. | 3 |
| “Memory capacity”: 2 M | 5 |
| “Number of LSIs”: | 3 |
| Click memory = 4 and ASIC = 2. | |
| “Number of gates of the above”: | 3 |
| Click ASIC = 200 k | |
| “Number of ICs”: Click 3. | 3 |
| “Number of gates of the above”: Click 5 k. | 4 |
| “Total of other electric parts”: Click 26. | 3 |

The above items and specification code are examples for the purpose of facilitating explanation.

5) In identification of specifications (3) shown in FIG. 13, as described above, specifications showing added value which cannot be grasped by the relevant electrical schematic diagrams only, such as presence of patents, presence of firmware, presence of LSI, etc. are identified. In the illustrated example, items are marked as no presence. Consequently, in the specifications of FIG. 13, 5a, 6a, and 7a are obtained, respectively. If any added value specification is present, contents that grade the value in 10 levels are recited.

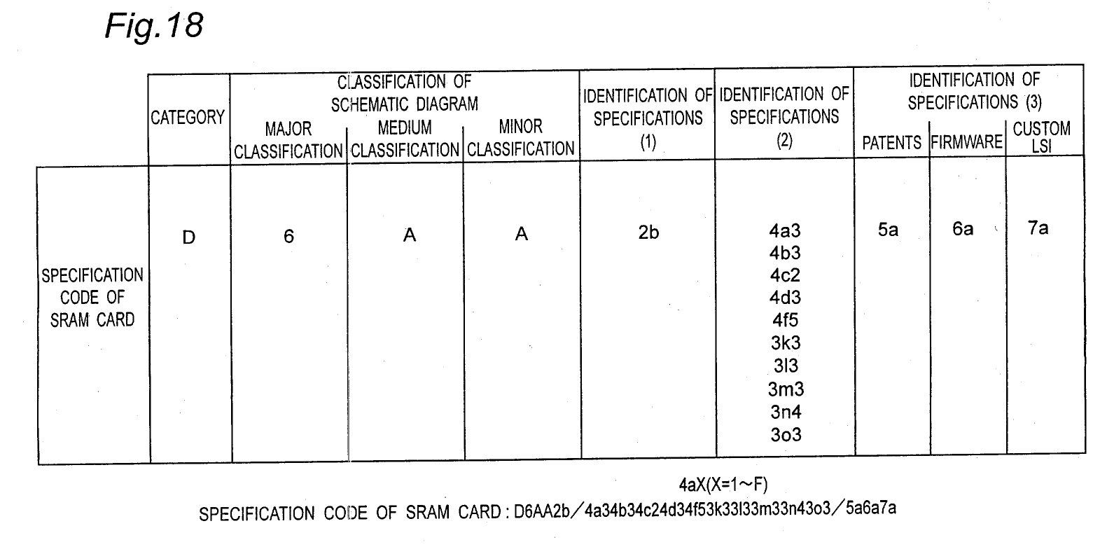

When selection and entry of specifications (clicking operation) are completed, codes allocated to each specification are automatically created internally. FIG. 18 is an example that indicates specification codes automatically created. In the case of 2M-byte SRAM card in this example, the specification code is D6AA2b/4a34b34c24d34f53k33l33m33n43o3/5a6a7a. Code 0 may be allocated if 5a, 6a and 7a are not present. In such an event, the code may be omitted.

The specification code is temporarily stored in HDD36 of seller terminal 1 (FIG. 3) in accordance with the procedures of specification code setting program or outputted from memory 33 (FIG. 3) to intermediary server 4 (FIG. 4) together with electrical schematic diagram data.

Referring now to FIG. 6 again, intermediary server 4 checks whether specification codes are correctly added and whether there is any wrong entry when it receives electrical schematic diagram data and the specification codes from seller terminal 1. If there is no problem, intermediary server 4 stores the electrical schematic diagram and specification codes received in HDD46 (FIG. 4) (Step S62). If there are any problems, intermediary server 4 notifies seller terminal 1 and prompts the user to re-enter the entries.

When intermediary server 4 stores electrical schematic diagram data and specification codes in HDD46 (FIG. 4), intermediary server 4 executes the transaction data evaluation program 47-3 (FIG. 4) and specification reproduction program.

First of all, explanation will be made on execution of the transaction data evaluation program. By executing this program, CPU41 (FIG. 4) calculates a total of each score in category (FIG. 7), connection division (FIG. 10), and identification of specifications (1) through (3) (FIGS. 11 through 13) for which scores are set in advance for each specification. The calculation result becomes an overall score of electrical schematic diagram. The overall score will be utilized in calculating prices of electrical schematic diagrams, which will be later discussed.

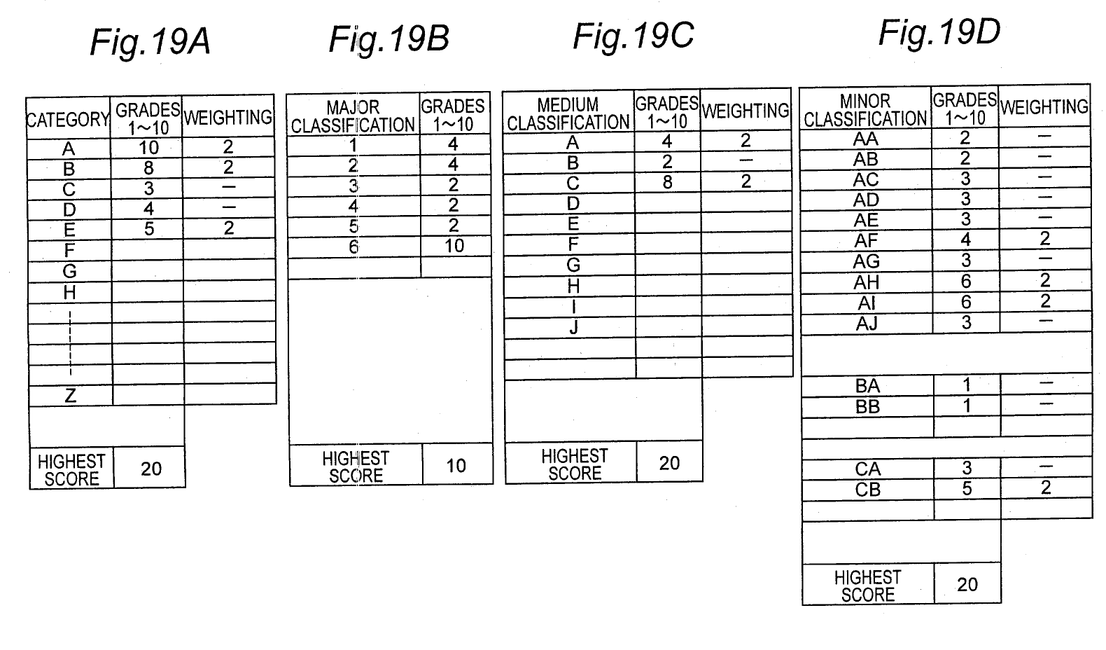

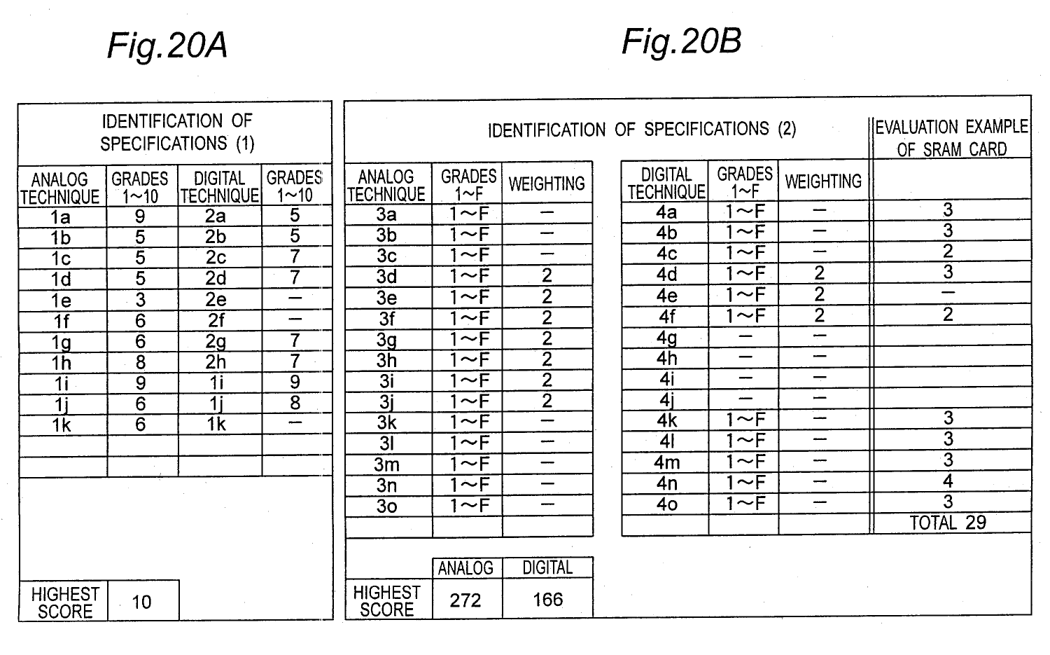

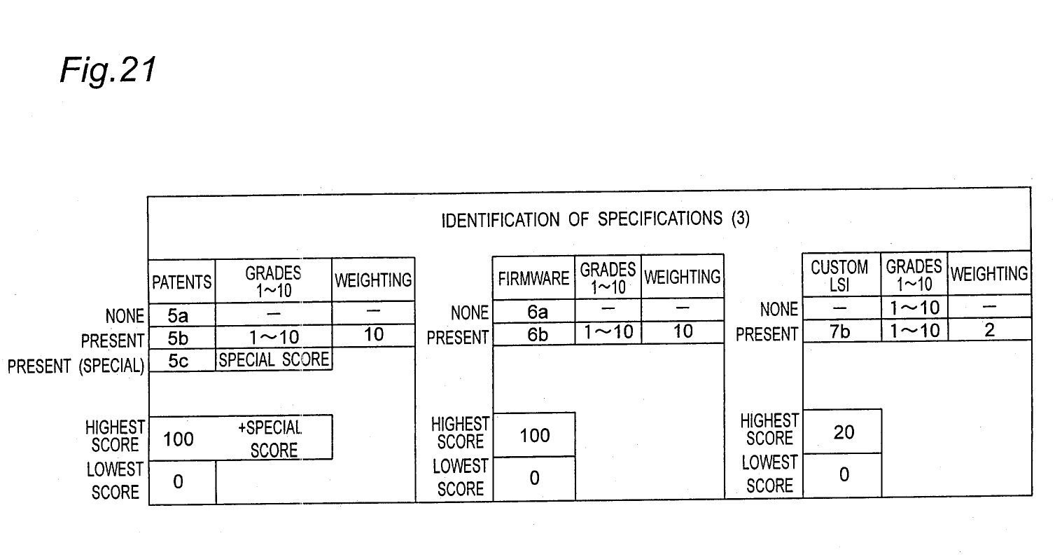

FIGS. 19A through 19D, 20A, 20B and 21 show examples of predetermined scores. FIGS. 19A through 19D are illustrations, each showing an example of score determined with respect to category and connection diagram classification. FIGS. 20A and 20B are illustrations, each showing an example of score determined with respect to identification of specifications (1) and (2). FIG. 21 is an illustration showing an example of score determined with respect to identification of specifications (3). It is understood that in all of the illustrations, scores are prescribed for each item that determines specifications. Note that for items for which the added value is assumed to be high among specifications, numerical values different from predetermined scores are established as “weighting.” The scores of items with established weighting are calculated by multiplying the predetermined scores by weighted values. For example, in the case that the predetermined score is 6 and weighted value is 2, the score becomes 12. Items which are weighted can be set by providing optional standards other than the level of added value. The predetermined scores and specification items may be periodically updated in view of market trends, etc.

CPU41 (FIG. 4) determines the price of electrical schematic diagram in accordance with the score when it calculates the overall score. The price can be obtained by multiplying the price (unit price) per one point of overall score by the overall score.

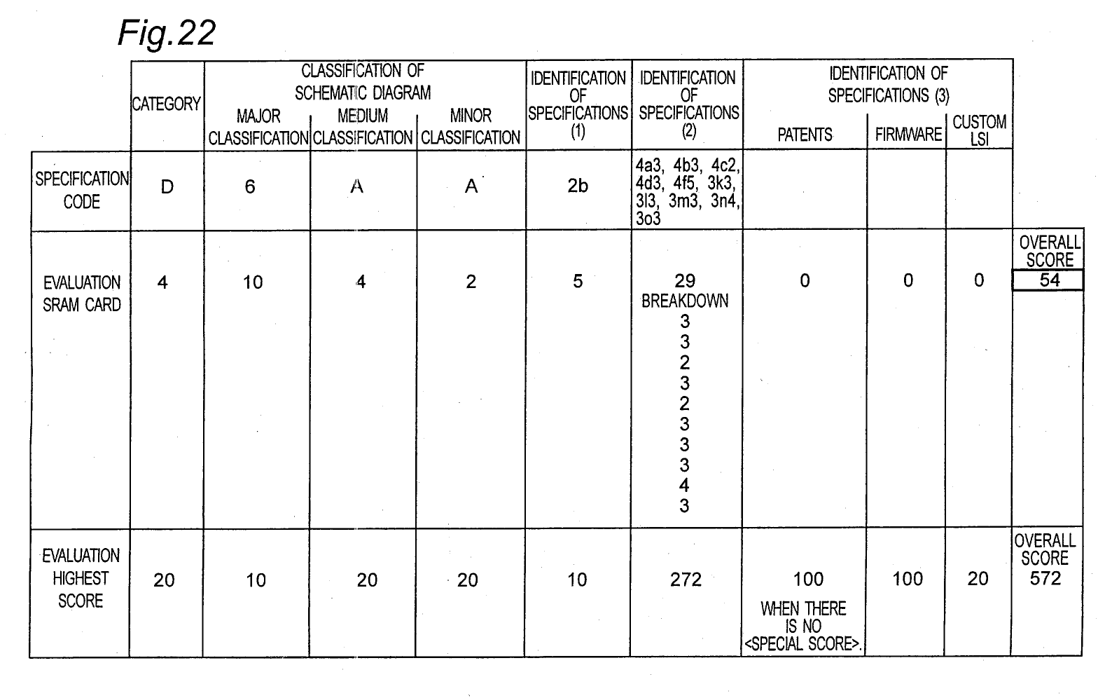

FIG. 22 is an illustration showing calculation results of scores of SRAM cards which have acquired specification codes shown in FIG. 18. Scores are calculated for category, major, medium, and minor classifications of connection diagrams, and each classification of specifications (1) through (3) and the overall score (54 points) is obtained. Just for reference, the highest score of each classification is shown on the lowermost column. Now assume that the unit price is 10,000 yen; then, the price of electrical schematic diagram is calculated as 540,000 yen. The unit price can be periodically updated in view of market trends, etc.

Next description will be made on execution of the specification reproduction program. By executing this program, CPU41 (FIG. 4) analyzes specification codes stored in HDD46 (FIG. 4) and obtains specifications of relevant electrical schematic diagrams. In the present specification, this action is called “reproduction”. Reproduction of specification codes can be achieved by procedures reversal to setting of specification codes in seller terminal 1 (FIG. 3).

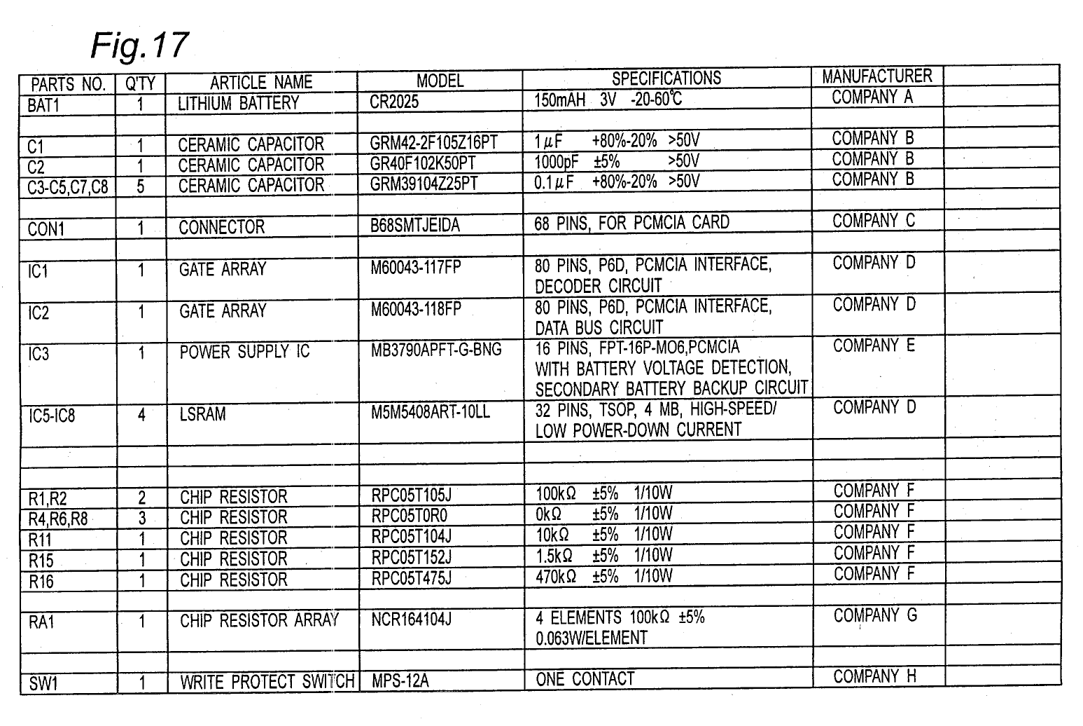

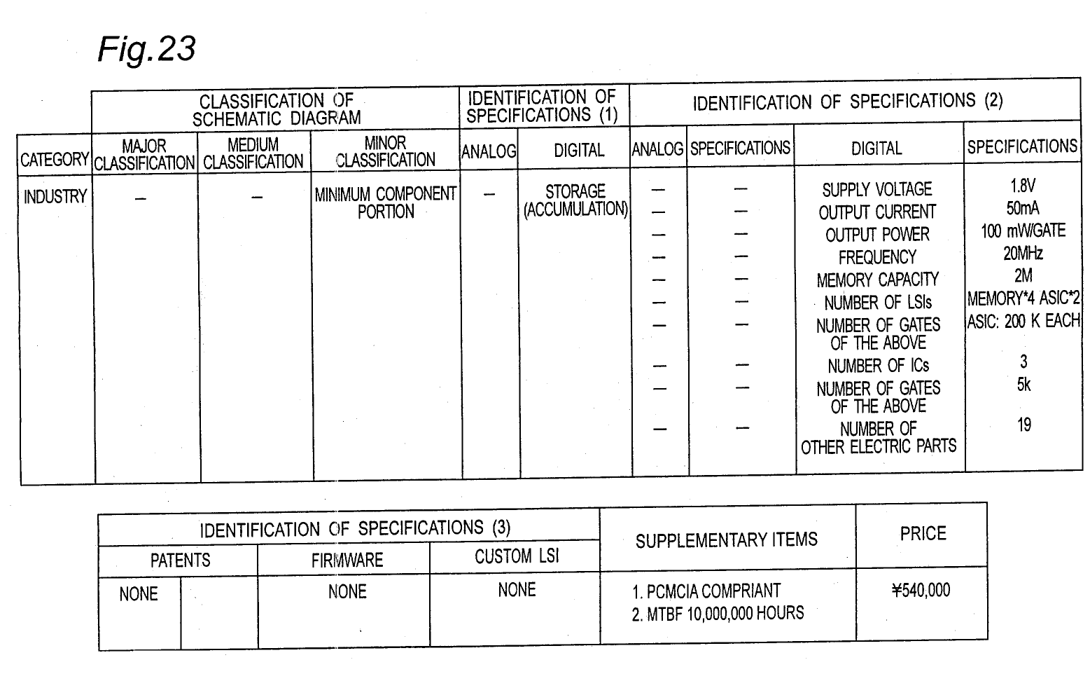

By executing the transaction data evaluation program and specification reproduction program, intermediary server 4 (FIG. 4) obtains titles of relevant electrical schematic diagrams, their specifications table, and price of electrical schematic diagrams. Consequently, via a transaction indicating column of a Web site operated on intermediary server 4, buyer terminal 2 (FIG. 1), etc. can search with specifications used as a key and display the results. FIG. 23 is an illustration showing an example of list of information (main specifications, incidental matters, prices, etc.) related to electrical schematic diagrams of SRM described referring to FIGS. 14 through 17. FIGS. 14 through 16 are illustrations shown interconnections of an electric circuit and FIG. 17 is a list of parts composing the electric circuit.

Referring now to FIG. 6 again, explanation is made from actions of buyer terminal. Buyer terminal accesses a Web site of (1) and can search and inspect whether a desired electrical schematic diagram is present as well as title of the electrical schematic diagram, list of its specifications, and price list.

Now, description will be made on procedures when a user on buyer terminal 2 hopes to purchase the electrical schematic diagram. Buyer terminal 2 notifies Intermediary server 4 of a purchase request of electrical schematic diagram from a Web site, etc. of intermediary server 4 (Step S63). It transmits specifications of apparatus related to the desired electrical schematic diagram (Step S64).

Intermediary server 4 searches appropriate one or more electrical schematic diagrams that match the desire of the user on buyer terminal 2 with the specifications received from buyer terminal 2 used as a key. When it finds appropriate electrical schematic diagrams, intermediary server 4 displays related information on electrical schematic diagrams as shown in FIG. 23 on the Web site (Step S65).

The user on buyer terminal 2 refers information such as titles of electrical schematic diagrams, specifications, etc. held on intermediary server 4 and decides whether to buy the electrical schematic diagrams or not. The decision is notified to intermediary server 4 from the Web site, etc. of intermediary server 4 again.

In the case that the user on buyer terminal 2 thinks that s/he cannot decide the purchase only by the display of titles, etc. of electrical schematic diagrams, the user enters an instruction for requesting sample data of the diagrams. Then, CPU51 (FIG. 5) of buyer terminal 2 requires samples of electrical schematic diagrams of intermediary server 4 (Step S66). Intermediary server 4 transmits sample data of the specified electrical schematic diagrams to buyer terminal 2 (Step S67). These sample data are sample data 46-2 (FIG. 4) stored in HDD 46 (FIG. 4) of intermediary server 4.

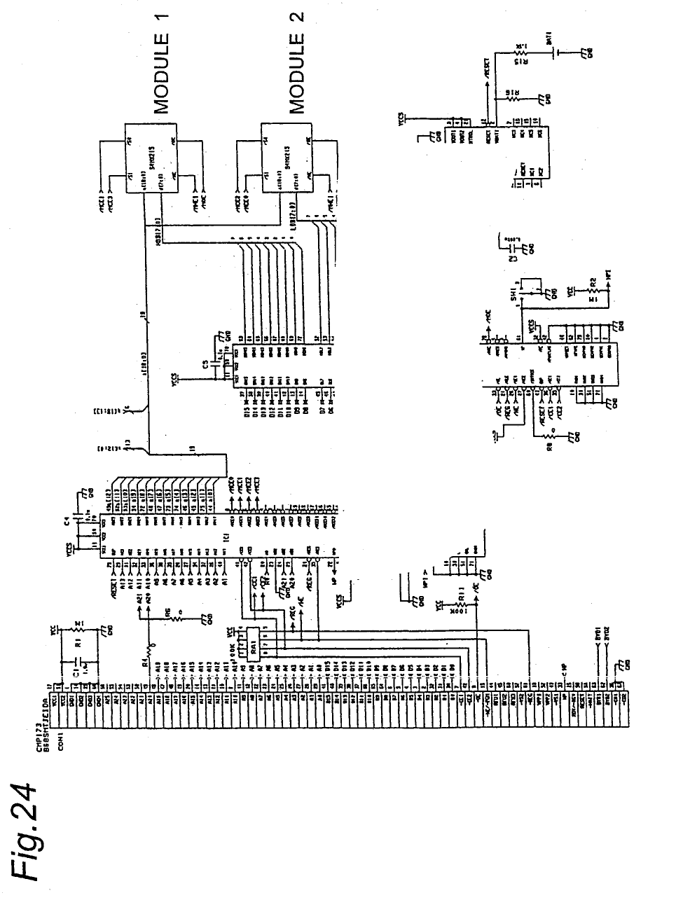

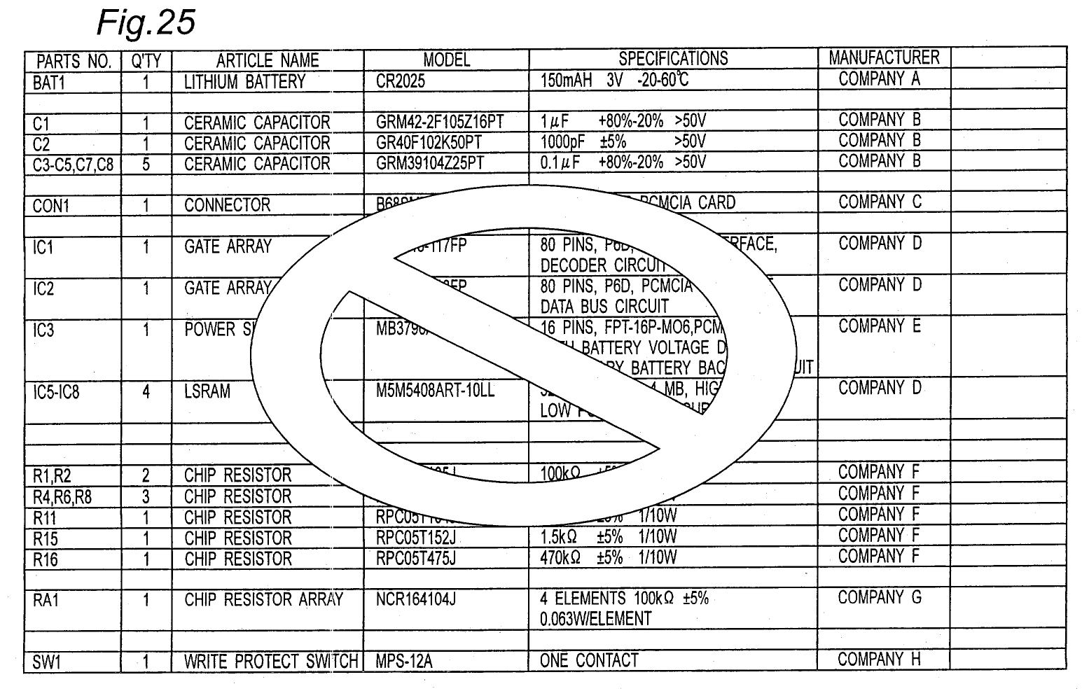

FIG. 24 is an illustration showing a display of sample data concerning circuit diagram. FIG. 25 is an illustration showing a display of sample data concerning parts list. As described above, as the electrical schematic diagram includes a list of parts composing the circuit and drawings that describe interconnections, etc. of wiring of the parts, sample data are displayed for each of circuit diagram and parts list, respectively. In the sample data, principal portions for the electrical schematic diagram to be transacted is hidden, therefore, the complete electrical schematic diagram cannot be restored as it is.

If the buyer has decided to purchase the electrical schematic diagram by inspection of samples, etc., CPU 51 (FIG. 5) of buyer terminal 2 notifies intermediary server 4 of its decision of purchase and settles account by transmitting information including credit card No., etc. (Step S68). As a result, CPU51 (FIG. 5) of buyer terminal 2 acquires electrical schematic diagram data transmitted from intermediary server 4 and stores the data in HDD56. It must be noted that in the electrical schematic diagram obtained by buyer terminal 2, specification codes are removed from the data. That is, buyer terminal 2 obtains the electrical schematic diagram only.

In the case that a purchase request is notified based on the search result and that the electrical schematic diagram intended to be purchased has already been decided, there is no need to transmit specifications of the apparatus. In such an event, actions take place in order of Step S64, S65, and S63.

Note that, in the present specification, it is described that specification codes are set on the seller terminal side. However, this may be carried out in the intermediary server.

As mentioned above, the embodiment of the present invention has been described.

According to the present invention, a seller terminal can receive a specification code setting program for setting specification codes via networks, enters the specification codes based on procedures of the program, and can set the specification codes. Consequently, the seller terminal can set uniform specification codes.

In addition, an intermediary server restores contents of each specification from the specification codes received from the seller terminal using the specification reproduction program for restoring the specifications from specification codes and transmits the contents of the specifications to a buyer terminal. According to this procedure, on the buyer terminal side, the specifications of the required electrical schematic diagram can be obtained and purchase processing on the buyer terminal side can be facilitated.

The contents of specifications can be inspected on a Web site page operated on the intermediary server. That is, since the existing World Wide Web system can be utilized as it is, this data trading system can be easily adopted.

The intermediary server gives scores to each specification and calculates scores that match each established specification with respect to the specification codes received from the buyer terminal according to the evaluation program which evaluates a value of the data of the electrical schematic diagram. Accordingly, an objective value of the electrical schematic diagram can be judged based on the specifications.

The evaluation program can flexibly give marks in accordance with specifications because weighting parameters are used for at least one specification and each specification is graded. Consequently, the value of electrical schematic diagram can be judged more objectively.

Because electrical schematic diagrams are evaluated using not only each specification but also the total point of scores in accordance with each specification, comprehensive evaluation can be carried out. To be more in detail, since the intermediary server decides a price of an electrical schematic diagram based on the total point of scores, the value of electrical schematic diagram judged from specifications can be reflected to the price.

The intermediary server sets masks to principal places of electrical schematic diagrams received from the seller terminal. By preparing the sample data of electrical schematic diagrams masked in advance, the sample data can be immediately provided if required.

The intermediary server responds to the sample data request received from the seller terminal and transmits the sample data to the buyer terminal. Thus, the user on the buyer terminal can judge whether the electrical schematic diagram is suited for purchase or not by inspecting the sample data, which is a summary of the electrical schematic diagram.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data trading system including:
a seller terminal which transmits a selling request representing a desire for selling data relevant to a technology and the data through network;
a buyer terminal which transmits a buying request representing a desire for buying the data through the network; and
an intermediary terminal having a storage which holds the data received from the seller terminal and a processor which transmits the data stored in the storage to the buyer terminal in receipt of the selling request received from the seller terminal and the buying request received from the buyer terminal,
wherein the seller terminal comprises an input unit which is used for entering a specification code that represent specification describing contents of the technology, and transmits the specification code entered from the input unit together with the data, and
wherein the intermediary terminal further stores the specification code in the storage transmitted from the seller terminal and transmits the contents of the specification to the buyer terminal in receipt of a request from the buyer terminal.

2. The data trading system according to claim 1,
wherein the data relevant to the technology is data of an electrical schematic diagram which includes a drawing describing interconnections of wiring of an electric circuit and a list of parts which are components of the electric circuit,
wherein the specification represented by the specification codes includes at least one of market field of the electric circuit shown by the electrical schematic diagram, a division that indicates a position to be connected in an electric system, a technology field, characteristics, an electric function, an electrical property, and an added value function.

3. The data trading system according to claim 2,
wherein the storage of the intermediary server further stores a specification code setting program which sets the specification code, and
wherein the seller terminal receives the specification code setting program via the network, and enters and sets the specification code via the input unit according to a processing procedure of the specification code setting program.

4. The data trading system according to claim 3, wherein the storage of the intermediary server further stores a specification reproduction program which restores the specification from the specification code, and the processor of the intermediary server restores the contents of the specification from the specification code received from the seller terminal and transmits the contents of the specification to the buyer terminal.

5. The data trading system according to claim 4, wherein the buyer terminal further comprises a display unit whcih receives and displays a Web site page operated on the intermediary server, and the contents of the specification are included on the Web site page.

6. The data trading system according to claim 3,
wherein the storage of the intermediary server further stores an evaluation program which gives a grade to the specification and evaluates a value of the data of the electrical schematic diagram,
wherein the processor calculates the grade according to the evaluated specification with respect to the specification codes received from the seller terminal based on the evaluation program.

7. The data trading system according to claim 6, wherein the evaluation program gives grades to at least one specification by using a weighing parameter for the at least one specification.

8. The data trading system according to claim 6, wherein the processor of the intermediary server calculates a total point of grades based on the at least one specification and evaluates the electrical schematic diagram.

9. The data trading system according to claim 8, wherein the processor of the intermediary server determines a price of the electrical schematic diagram based on the total point.

10. The data trading system according to claim 2,
wherein the intermediary server further comprises an input unit which sets a mask to a main place of the electrical schematic diagram received from the seller terminal, and
wherein the electrical schematic diagram with the mask set by the input unit are further stored in the storage of the intermediary server as sample data.

11. The data trading system according to claim 10,
wherein the buyer terminal transmits a sample data request representing a desire for transmitting the sample data, and
wherein the intermediary server responds to the sample data request from the buyer terminal and further transmits the sample data stored in the storage of the intermediary server to the buyer terminal.
